(19) United States
(12) Patent Application Publication
(10) Pub. No.: US 2019/0154510 A1
(43) Pub. Date: May 23, 2019

(54) Method for Determining a Temperature without Contact and Infrared Measuring System

(71) Applicant: Robert Bosch GmbH, Stuttgart (DE)

(72) Inventors: Michael Frank, Bretten (DE); Volkmar Senz, Metzingen (DE); Michael Badeja, Breisach (DE); Axel Rumberg, Karlsruhe (DE); Michael Krueger, Reutlingen (DE); Helge Dittmer, Hamburg (DE)

(21) Appl. No.: 16/313,815

(22) PCT Filed: Jun. 14, 2017
(86) PCT No.: PCT/EP2017/064505

§ 371 Date: Dec. 27, 2018

(30) Foreign Application Priority Data
Jun. 30, 2016 (DE) 10 2016 211 812.9

(51) Int. Cl. G01J 5/02; G01J 5/06; G01J 5/08; G01J 5/52; H04N 5/33

(52) U.S. Cl. CPC G01J 5/025; G01J 5/0265; G01J 5/06; G01J 2005/0048; G01J 5/522; H04N 5/33; G01J 5/0859

(57) ABSTRACT

A method for contactlessly establishing a temperature of a surface includes determining the temperature measurement values of the plurality of measurement pixels. The method further includes correcting the temperature measurement values by using in each case a pixel-associated temperature drift component. The method further includes at least temporarily suppressing an incidence of infrared radiation onto the infrared detector array using the closure mechanism of the infrared measurement system while temperature measurement values are being determined. The method further includes determining the temperature drift components using the temperature measurement values.

The invention relates to a method for contactlessly establishing a temperature of a surface, in particular for contactlessly establishing a temperature distribution on a surface, and a corresponding infrared measurement system.

### PRIOR ART

Apparatuses and methods for contactlessly establishing a temperature of a surface, in particular for contactlessly establishing a temperature distribution on a surface, are known in the prior art and find use in many applications, for example for checking the safety of electronic circuits, for seeking defects in machine processes or for identifying insufficient thermal insulation within the scope of hot and/or cold insulation. Compared to conventional temperature measurement appliances, infrared thermometers have the advantage of contactless and fast measurements and can be used, in particular, if regions to be measured are only accessible with difficulties or not accessible at all. Here, the temperature measurement by means of an infrared-sensitive thermometer is based on the detection of thermal radiation, i.e., infrared radiation, in particular in a wavelength range between 3 μm and 50 μm, which is emitted by every object with a different intensity depending on the temperature, in particular the surface temperature, thereof. A surface temperature of the emitting body can be determined using the temperature measurement appliance on the basis of a measured intensity of the emitted thermal radiation.

Infrared thermometers known from the prior art can be essentially classified into two embodiments. Apparatuses of the first type, so-called spot thermometers, typically comprise an infrared sensor, a lens and a display and typically have a conical, preferably small measurement volume, from which thermal radiation is detected. U.S. Pat. No. 6,659,639 A1 and US 2009/0304042 A1 describe apparatuses and methods of a measurement appliance of this type.

Infrared thermometers of a second type, so-called thermal imaging cameras, by contrast typically have an infrared-sensitive image sensor, a lens system and a screen and allow the examination of an object in the infrared range of the radiation spectrum in a manner similar to a camera operating in the visual spectral range and allow output on the screen as a two-dimensional, color-coded image of the object. Apparatuses and methods of this second type are described by US 2009/0302219 A1 and U.S. Pat. No. 7,652,251 A1.

DE 20 2013 008 745 U1 has disclosed a thermal imaging camera with a sensor field having sensor pixels, in which a stop is arranged in the beam path of the thermal imaging camera, the projection and/or the shadow cast by said stop subdividing the sensor field into at least one shadowed region containing at least one sensor pixel and into at least one non-shadowed region. Use of a measurement and/or reference value established by the at least one shadowed sensor pixel allows an offset correction of the thermal imaging camera to be carried out without a shutter (closure element) that covers all sensor pixels at least intermittently.

Further, DE 10 2008 041 750 A1 has disclosed a microstructured reference pixel for sensors, said reference pixel changing an electric property in its value in temperature-dependent fashion and being thermally coupled to a substrate but electrically insulated from said substrate. A temperature to be measured is determined in a method for operating a temperature sensor using this reference pixel, with the reference pixel being used for referencing purposes.

### DISCLOSURE OF THE INVENTION

The invention proceeds from an infrared measurement system, in particular a handheld thermal imaging camera, for contactlessly establishing a temperature of a surface, in particular for contactlessly establishing a temperature distribution on a surface. The infrared measurement system has at least one infrared detector array with a plurality of measurement pixels, which each provide a measurement signal for establishing a temperature measurement value T_{MP} which is dependent on an intensity of the incident infrared radiation, and a closure mechanism for suppressing an incidence of infrared radiation onto the infrared detector array. According to the invention, an evaluation apparatus of the infrared measurement system is configured to carry out the method according to the invention for contactlessly establishing a temperature of a surface, in particular for contactlessly establishing a temperature distribution on a surface.

Underlying the method there is an infrared measurement system, in particular a handheld thermal imaging camera, for contactlessly establishing a temperature distribution on a surface, as described below.

The infrared measurement system, in particular the handheld thermal imaging camera, is configured to detect, in particular in contactless fashion, infrared radiation, in particular thermal radiation, emitted from a measurement region on the surface. The infrared measurement system is provided to output an information item relating to a temperature of the surface. Advantageously, this information item can be realized as one or more temperature specifications or as a temperature distribution, particularly advantageously as a thermal image that is composed of a multiplicity of temperature specifications established in a spatially resolved fashion.

The “measurement region” is understood to mean a geometric, delimited region which comprises a number of particles or regions of the object, the thermal radiation of which departs from the object in the direction of the infrared measurement system and is at least partly captured by the latter. Depending on the material of the object, in particular depending on the transparency of the object to infrared radiation, the infrared measurement system may capture particles or regions which are at various distances within the object. In particular, in addition to a solid, an “object” can also be understood to mean a fluid, in particular a liquid and a gas, whose temperature can be measured in analogous fashion. In order to simplify the following description, “measurement region” denotes, in particular, the region on an object surface that substantially emerges from the intersection between a measurement volume—the volume from which the apparatus according to the invention captures thermal radiation—and the surface of the object to be examined. Depending on the material properties of the object, this measurement region may, however, also comprise thermal radiation from deeper layers within the object.

The infrared measurement system, in particular the handheld thermal imaging camera, comprises at least one infrared detector array and an evaluation apparatus. Further, in one embodiment of the infrared measurement system, the infrared measurement system may comprise an optical unit, in particular an imaging optical unit. An optical unit is provided to project thermal radiation emitted from the measurement region in the infrared spectrum, preferably in the mid-wavelength infrared spectrum in the wavelength range between 3 μm and 50 μm, onto a surface of the infrared detector array of the infrared measurement system that, from the view of the object, is arranged downstream of the optical unit. In one embodiment of the infrared measurement system, the optical unit also can be provided to project an image of the measurement region onto a surface of the infrared detector array, preferably to focus an image of the measurement region onto a surface of the infrared detector array. To this end, an optical unit can comprise optical components that steer, guide, focus and/or otherwise influence the spatial propagation of thermal radiation, for example lenses, mirrors or the like. Further, an optical unit can be provided in one embodiment for changeably setting a size of the measurement region situated on the surface using the optical unit, in particular to continuously set this in “zoomable” fashion.

Below, “provided” should be specifically understood to mean “programmed”, “designed”, “configured” and/or “equipped”. An object being “provided” for a specific function should be understood to mean, in particular, that the object satisfies and/or carries out this specific function in at least one application and/or operating state or that said object is designed to satisfy this function.

The infrared detector array serves to capture infrared radiation emitted by the measurement region and guided onto the surface of the infrared detector array (nota bene: in this document, the terms “infrared radiation” and “thermal radiation” are used synonymously).

The infrared detector array has at least a plurality of measurement pixels. The measurement pixels of the infrared detector array are each arranged on a surface of the infrared detector array facing the object to be examined. The measurement pixels are sensitive to infrared radiation, in particular thermal radiation, incident from the measurement region. As a consequence of irradiation by infrared radiation with the power P_{MP}, a respective measurement pixel heats by ΔT_{MP}, wherein there is a change in an electrical resistance of the measurement pixel in relation to a current I_{MP} flowing through the measurement pixel on account of the heating. Consequently, there is a change in the voltage drop across the measurement pixel. In one embodiment of the infrared measurement system, this voltage can be used as a measurement signal.

The measurement pixels are provided to capture radiation from the infrared range, in particular from the mid-wavelength infrared range in the wavelength range between 3 μm and 50 μm, and to convert said radiation into a measurement signal, in particular into an electrical measurement signal U_{MP}. In particular, each measurement pixel is provided to provide an electrical measurement signal U_{MP}, in particular a potential, which correlates with the radiated-in thermal output P_{MP} of the infrared radiation on the measurement pixel. Consequently, the measurement pixels each provide a measurement signal U_{MP}, depending on the intensity of the incident infrared radiation, for establishing a temperature measurement value T_{MP}, which is likewise dependent on the intensity of the incident infrared radiation. In particular, reference is made to the fact that the respective measurement signals U_{MP} of each measurement pixel are provided, or can be provided, independently of one another.

A pixel-dependent temperature measurement value T_{MP} is establishable in each case from the measurement signals U_{MP} provided thus. Consequently assuming an illumination by means of infrared radiation—it is possible to establish a plurality of temperature measurement values T_{MP} using a plurality of measurement pixels (any plurality of measurement pixels) of the infrared detector array. In particular, an image information item for a thermal image can be established in this way from infrared radiation respectively emitted by the object to be examined in a solid angle of the measurement region.

In one embodiment of the infrared measurement system according to the invention, the measurement pixels are realized as p-n diodes (thermal diodes). In particular, the infrared detector array can be realized as a silicon sensor chip, for example, which has silicon as a detector array substrate. In this way, an infrared detector array can be advantageously realized as a semiconductor sensor using semiconductor technology.

Further, using p-n diodes advantageously renders it possible to capture small changes in the temperature to be measured, i.e., the infrared radiation, and/or to eliminate disturbance signals that are caused by the measurement electronics of the semiconductor sensor. By way of example, such disturbance signals can be a temperature drift caused by a changing temperature of the measurement electronics during operation. In particular, the measurement signals U_{MP} can also be established with reference to a reference signal U_{RP}, for example as a difference measurement signal U_{MP}−U_{RP} (voltage difference) in relation to a reference signal U_{RP} output by a reference pixel. In this way, it is possible to capture temperature changes, in particular changes in the intensity of the incident infrared radiation, which lead to small differences or changes in the measurement signals (e.g., in the mV range), by means of a difference amplifier in an advantageously accurate and highly resolved manner.

Each of the plurality of measurement pixels is signal-connectable to the evaluation apparatus of the infrared measurement system, either directly or indirectly via further interposed components. “Connecting a pixel” to the evaluation apparatus should be understood to mean, in particular, that the measurement signals U_{MP} provided by a measurement pixel, in one embodiment also established voltage differences U_{MP}—U_{RP}, are transmittable to the evaluation apparatus. In particular, this explicitly includes the measurement signals as voltage differences being transmitted by a difference amplifier or a comparable electrical component to the evaluation apparatus. In particular, an indirect signal-connection of the measurement pixels to the evaluation apparatus also can be realized by way of switching elements, e.g., multiplexers or other selection circuits, which are designed to selectively transmit detection signals of a plurality of measurement pixels. What this can achieve, in particular, is that detection signals of individual measurement pixels or a group of measurement pixels can be transmitted to the evaluation apparatus independently of the detection signals of other measurement pixels and can be evaluated by said evaluation apparatus.

The evaluation apparatus for receiving and evaluating measurement signals of the infrared detector array should be understood to mean an apparatus comprising at least one information input for receiving measurement signals, an information processing unit for processing, in particular evaluating, the received measurement signals, and an information output for transmitting the processed and/or evaluated measurement signals. Processed and/or evaluated measurement signals should be understood to mean, in particular, evaluated temperature measurement values T_{MP}. Advantageously, the evaluation apparatus has components which comprise at least one processor, a memory and an operating program with evaluation and calculation routines. In particular, the electronic components of the evaluation apparatus can be arranged on a circuit board (printed circuit board), preferably on a common circuit board with a control apparatus of the infrared measurement system for controlling the infrared measurement system and, particularly preferably, in the form of a microcontroller. Moreover, the control apparatus and the evaluation apparatus can also be embodied as a single component.

The evaluation apparatus is provided to receive and evaluate measurement signals provided by the infrared detector array and to carry out an evaluation of the temperature of the measurement region on the basis of measurement signals from at least a plurality of measurement pixels of the infrared detector array. In particular, the evaluation apparatus is provided to carry out an evaluation of one or more temperature measurement values T_{MP} on the basis of measurement signals of at least a plurality (any plurality) of measurement pixels of the infrared detector array. The evaluated temperature measurement values T_{MP} can be provided by the evaluation apparatus for further processing and/or for output purposes, in particular for output to a user of the infrared measurement system by means of an output apparatus and/or for output to an external appliance by means of a data communications interface.

In one embodiment of the infrared measurement system, the plurality of measurement pixels are arranged in matrix-like fashion on the surface of the detector array substrate. By way of example, the measurement pixels number 80×80 pixels, preferably 360×240 pixels, particularly preferably 640×480 pixels. Any other values are conceivable. The number of measurement pixels defines the resolution of the infrared measurement system, i.e., in particular, the resolution of a thermal image, measured by means of the infrared measurement system, of an object to be examined. In this way, there can be a particularly homogeneous and, in particular, gap-free capture of infrared radiation from the solid angle range since the infrared detector array is provided with measurement pixels in homogeneous and, in particular, gap-free fashion.

The infrared measurement system has a closure element which is provided to at least temporarily suppress an incidence of infrared radiation onto the infrared detector array. By way of example, such a closure mechanism can be realized in the form of a shutter. In the case of a closed closure mechanism, established temperature measurement values are referred to as temperature measurement values T_{MP}^{blind} of the measurement pixels. Here, the temperature measurement values T_{MP}^{blind} substantially correspond to the temperature of the closure mechanism. The label “blind” in this case denotes the property of the infrared measurement system of detecting no infrared radiation emitted from outside of the infrared measurement system, for example from an object to be examined. For control thereof, the closure mechanism is signal-connected to the control device of the infrared measurement system.

The described infrared measurement system serves as a basis for the method, described below, for contactlessly establishing a temperature of a surface, in particular for contactlessly establishing a temperature distribution on a surface.

The method serves primarily for correcting a pixel-associated temperature drift component T_{drift}, by means of which the temperature measurement values T_{MP} established from the measurement signals of the respective measurement pixels are displaced (“drift”) in time-dependent fashion. The aging of the infrared detector array as a result of detector-array-intrinsic effects such as, in particular, charge shifts in the individual measurement pixels is a substantial influencing variable on this displacement, or else “temperature drift”. The temperature drift of the individual measurement pixels is expressed, in particular, by time-varying deviations (“offsets”) of the measurement signals output by the respective measurement pixels and consequently also by temporal deviations of the temperature measurement values T_{MP} determined from the measurement signals of the respective measurement pixels. Expressed vividly, different temperature measurement values T_{MP} are established in time-dependent fashion in the case of an unchanged temperature of the infrared detector array and in the case of an unchanged incidence of infrared radiation. This time-dependent displacement of the temperature measurement values leads to the output of a continuously falsifying examination result of the temperature to be established on the surface.

Currently, such unwanted effects are corrected by the use of closure elements such as, e.g., a “shutter”. Here, the temperature of the closure element must be known. The temperature drift can be subsequently corrected once this temperature is known.

Here, the method according to the invention for contactlessly establishing a temperature of a surface, in particular for contactlessly establishing a temperature distribution on a surface, proceeds from the infrared measurement system, already presented above, which at least comprises:
an infrared detector array with a plurality of measurement pixels, which each provide a measurement signal for establishing a temperature measurement value T_{MP} which is dependent on an intensity of the incident infrared radiation, and
a closure mechanism for suppressing an incidence of infrared radiation onto the infrared detector array,
and wherein the method comprises at least the following steps:
determining the temperature measurement values T_{MP} of a plurality of measurement pixels;
correcting temperature measurement values T_{MP} by in each case a pixel-associated temperature drift component T_{drift}.

According to the invention,
an incidence of infrared radiation onto the infrared detector array is at least temporarily suppressed by means of the closure mechanism of the infrared measurement system while temperature measurement values T_{MP}^{blind} are being established, and
the temperature drift components T_{drift} are determined using temperature measurement values T_{MP}^{blind}.

In particular, the evaluation apparatus is provided to carry out the method according to the invention for contactlessly establishing a temperature of a surface, in particular for contactlessly establishing a temperature distribution on a surface.

“Determining the temperature measurement values T_{MP} of a plurality of measurement pixels” should be understood to mean, in particular, that measurement signals U_{MP} (or also U_{MP}−U_{RP}) are initially provided from any plurality of measurement pixels and said measurement signals are transmitted to the evaluation apparatus. From these provided measurement signals, the evaluation apparatus evaluates associated temperature measurement values T_{MP} for the corresponding measurement pixels. Examined more closely, the evaluation apparatus in each case naturally evaluates a pixel-dependent temperature measurement value T_{MP}ⁱ for corresponding measurement pixels i. Here, “pixel-dependent” means, in particular, that the respective temperature measurement value (index “i”) is uniquely assigned to a certain measurement pixel (i). Thus, below, both the individual temperature measurement values—i.e., T_{MP}ⁱ—and, analogous thereto, also the temperature drift components T_{drift}^{k} established for a certain measurement pixel k are combined as respective sets T_{MP} and T_{drift} in order to avoid unnecessary confusion as a result of indices.

Reference is made to the fact that the plurality of measurement pixels can correspond to any plurality, which need not necessarily correspond to the totality of the available measurement pixels. Therefore, the set of evaluated measurement pixels can be smaller than the set of measurement pixels available overall on the infrared detector array.

In one embodiment of the method, the individual temperature measurement values T_{MP} can be realized as values characterizing the temperature of the surface to be examined, for example in degrees Celsius (° C.) or Kelvin (K) or the like.

“Determining the temperature drift components T_{drift} using temperature measurement values T_{MP}^{blind}” should be understood to mean that the temperature measurement values T_{MP}^{blind} are used to evaluate the respective, pixel-dependent temperature drift components T_{drift} for the measurement pixels. The temperature measurement values T_{MP}^{blind} denote those temperature measurement values T_{MP} which are established by the measurement pixels when the incidence of infrared radiation onto the infrared detector array is suppressed by the closure mechanism. Here, the temperature measurement values T_{MP}^{blind} of the measurement pixels, established when the closure mechanism is closed, correspond to the temperature of the closure mechanism. The label “blind” in this case denotes the property of the infrared measurement system of detecting no infrared radiation emitted from outside of the infrared measurement system, for example from an object to be examined.

“Correcting temperature measurement values T_{MP} by pixel-associated temperature drift components T_{drift} in each case” denotes a correction which is applied or can be applied to each measurement pixel of the plurality of measurement pixels for which temperature measurement values T_{MP} are determined. In one embodiment of the method, this can be implemented, in particular, by virtue of a temperature measurement value T_{MP} established for a respective measurement pixel having added or subtracted thereto an associated temperature drift component T_{drift} that is established for this measurement pixel, i.e.,

T_{MP}^{corr}=T_{MP}+T_{drift}.

According to the invention, this allows a temperature measurement variable T_{MP}^{blind} that is independent of the incident infrared radiation to be used for correcting the drift temperature. Consequently, an evaluation result of the infrared measurement system, in particular the temperature of a surface to be established by means of the method according to the invention, can be improved in respect of accuracy.

In one embodiment of the method according to the invention, the temperature drift components T_{drift} are determined repeatedly at time intervals, in particular regularly, preferably continuously or virtually continuously.

What can be realized by the repeated determination of the temperature drift components T_{drift} at time intervals is an implementation of a likewise repeated correction in relation to the temperature drift components T_{drift} of the temperature output of the infrared measurement system to a user, in particular a thermal image. Advantageously, the evaluation apparatus is provided to facilitate a regular determination, in particular a continuous or virtually continuous determination, of the temperature drift components T_{drift} and consequently a regular correction, in particular a continuous or virtually continuous correction, of the established temperature, in particular of the thermal image, as a result of the high processing rate of the temperature measurement values. “Virtually continuous” should be understood to mean that, in particular, the repeated correction has an appliance-internal processing time in the evaluation apparatus of less than 10 seconds, preferably of less than 5 seconds, particularly preferably of less than 1 second before the correction of the temperature measurement values T_{MP} is complete. In this way, a user of the infrared measurement system has the impression that the temperature established for the examined surface, in particular the thermal image, is corrected immediately, preferably in real time and continuously.

In one embodiment of the method according to the invention, a temperature drift behavior m_{MP} of the measurement pixels is determined from the temperature measurement values T_{MP}^{blind} for the purposes of determining the temperature drift components T_{drift}.

Advantageously, the temperature drift behavior m_{MP} of the measurement pixels represents a suitable measure for the temperature drift of the measurement pixels. In particular, the temperature drift behavior m_{MP} can be represented by a mathematical expression such as a function or a constant or the like, for example. Advantageously, this allows the temperature drift behavior m_{MP} of the measurement pixels to be used as a basis for determining the temperature drift components T_{drift}.

In one embodiment of the method according to the invention, the temperature drift behavior m_{MP} of the measurement pixels is determined as a constant of proportionality between initial measurement deviations T_{MP,offset} of the measurement pixels and temperature measurement values T_{MP}^{blind} for the purposes of determining the temperature drift components T_{drift}.

The “initial measurement deviation T_{MP,offset} of the measurement pixels” should be understood to mean, in particular, the pixel-dependent measurement deviation (“offset”) of the measurement pixels which are established during a factory calibration of the infrared measurement system. In particular, the evaluation apparatus of the infrared measurement system has the initial measurement deviations T_{MP,offset} available for each measurement pixel of the infrared detector array. Advantageously, these may be able to be recalled from a memory of the evaluation apparatus or of the infrared measurement system for each measurement pixel of the infrared detector array, with a unique assignment of initial measurement deviations T_{MP,offset} to the measurement pixels being ensured. In an embodiment of the infrared measurement system, the assignment of the initial measurement deviations T_{MP,offset} to the measurement pixels is stored in a table as an “initial offset map”.

In the proposed method, the temperature drift behavior m_{MP} of the measurement pixels is determined as a constant of proportionality between these initial measurement deviations T_{MP,offset} of the measurement pixels and the established temperature measurement values T_{MP}^{blind}. To this end, value pairs (T_{MP}^{blind}, T_{MP,offset}) are initially formed for each measurement pixel to be evaluated by the assignment of initial measurement deviations T_{MP,offset} to the respective measurement pixels.

When plotting the established temperature measurement values T_{MP}^{blind} on the ordinate axis against the initial measurement deviations T_{MP,offset} on the abscissa axis, a data set (“point cloud”) emerges, which can preferably be modeled (fitted) by way of a straight line, for example by using a least squares fit or the like. Subsequently, the temperature drift behavior m_{MP} of the measurement pixels can be established particularly easily and particularly exactly from the gradient (constant of proportionality) of this straight line. In particular, the following general equation applies to this straight line:

T_{MP}^{blind}=m_{MP}·(T_{MP,offset}⁰−T_{MP,offset}),

with an abscissa intercept T_{MP,offset}⁰. Reference is made to the fact that the image of the determination of the gradient serves illustrative purposes. In particular, the temperature drift behavior m_{MP} of the measurement pixels as a constant of proportionality can also be calculated by means of mathematical methods such as, for example, curve fitting or a linear regression calculation.

The method is based on the discovery that the temperature drift behavior m_{MP} of the measurement pixels can be determined particularly advantageously as a measure depending on the initial measurement deviation T_{MP,offset} of the respective measurement pixel, i.e., on the initial offset of the respective measurement pixel. This means that those measurement pixels which already have a comparatively large initial measurement deviation T_{MP,offset} (offset) at the time of the factory calibration are subject to a stronger temperature drift than measurement pixels which, at the time of the factory calibration, only have a small initial measurement deviation T_{MP,offset} (in terms of absolute value).

Advantageously, this can realize a determination of the temperature drift behavior m_{MP} of the measurement pixels that can be carried out in a particularly simple and fast manner. Further, requirements on the evaluation apparatus in respect of its computational power can be kept as low as possible using this determination method, and consequently it is possible to save costs.

In one embodiment of the method according to the invention, the temperature drift behavior m_{MP} of the measurement pixels is determined as a constant of proportionality between sensitivities of the initial measurement deviations ∂T_{MP,offset} in relation to the influences of aging of the measurement pixels and temperature measurement values T_{MP}^{blind} for the purposes of determining the temperature drift components T_{drift}.

The expression “sensitivities of the initial measurement deviations ∂T_{MP,offset} in relation to the influences of aging of the measurement pixels” (shortened below as “sensitivities of the initial measurement deviations a ∂T_{MP,offset}”) describes, in particular, a measure for the changeability of the initial measurement deviation T_{MP,offset} of the measurement pixels on account of an external physical influence which brings about artificially accelerated aging of the measurement pixels (“the susceptibility to changes of the offset values under the influence of aging”). Expressed differently, the “sensitivities of the initial measurement deviations ∂T_{MP,offset}” denotes the susceptibility of a measurement pixel to react to an external physical influence with a change in the initial measurement deviation T_{MP,offset} (i.e., in the offset). By way of example, such an external physical influence can be exerted by storage at a high temperature, a high current in the infrared detector array or the like.

“Sensitivities of the initial measurement deviations ∂T_{MP,offset} in relation to the influences of aging of the measurement pixels” should be understood to mean, in particular, those pixel dependent sensitivities of the initial measurement deviations ∂T_{MP,offset} in relation to the influences of aging of the measurement pixels which are established during a factory calibration of the infrared measurement system. In particular, the evaluation apparatus of the infrared measurement system has available the sensitivities of the initial measurement deviations ∂T_{MP,offset} for each measurement pixel of the infrared detector array. Advantageously, these may be able to be recalled from a memory of the evaluation apparatus or of the infrared measurement system for each blind pixel of the infrared detector array, with a unique assignment of sensitivities of the initial measurement deviations a T_{MP,offset} to the measurement pixels being ensured. In an embodiment of the infrared measurement system, the assignment of the sensitivities of the initial measurement deviations ∂T_{MP,offset} to the measurement pixels is stored in a table as an “initial drift susceptibility map”.

In the proposed method, the temperature drift behavior m_{MP} of the measurement pixels is determined as a constant of proportionality between these sensitivities of the initial measurement deviations ∂T_{MP,offset} of the measurement pixels and the established temperature measurement values T_{MP}^{blind}. To this end, value pairs (T_{MP}^{blind}, ∂T_{MP,offset}) are initially formed for each measurement pixel to be evaluated by the assignment of sensitivities of the initial measurement deviations ∂T_{MP,offset} to the respective measurement pixels. When plotting the established temperature measurement values T_{MP}^{blind} on the ordinate axis against the sensitivities of the initial measurement deviations ∂T_{MP,offset} on the abscissa axis, a data set (“point cloud”) emerges, which can preferably be modeled (fitted) by way of a straight line, for example by using a least squares fit or the like. Subsequently, the temperature drift behavior m_{MP} of the measurement pixels can be established particularly easily and particularly exactly from the gradient (constant of proportionality) of this straight line. In particular, the following general equation applies to this straight line:

T_{MP}^{blind}=m_{MP}(∂T_{MP,offset}⁰−∂T_{MP,offset}),

with an abscissa intercept ∂T_{MP,offset}⁰. Reference is made to the fact that the image of the determination of the gradient serves inter alia illustrative purposes. In particular, the temperature drift behavior m_{MP} of the measurement pixels as a constant of proportionality can also be calculated by means of mathematical methods such as, for example, curve fitting or a linear regression calculation.

The method is based on the discovery that the temperature drift behavior m_{MP} of the measurement pixels can be determined particularly advantageously as a measure depending on the sensitivity of the initial measurement deviation ∂T_{MP,offset} of the respective measurement pixel. This means that those measurement pixels which already exhibit signs for greater sensitivity of their initial measurement deviation in relation to the influence of aging at the time of the factory calibration are subject to a stronger temperature drift than measurement pixels which, at the time of the factory calibration, hardly have indications for such a sensitivity.

Advantageously, this can realize a determination of the temperature drift behavior m_{MP} of the measurement pixels that can be carried out in a particularly simple and fast manner. Further, requirements on the evaluation apparatus in respect of its computational power can be kept particularly low using this determination method, and consequently it is possible to save costs.

In one embodiment of the method according to the invention, the temperature drift components T_{drift} are determined from the temperature drift behavior m_{MP} of measurement pixels.

The temperature drift behavior m_{MP} of the measurement pixels can be advantageously used to determine the temperature drift components T_{drift} of the measurement pixels since it can be considered to be a measure of the temperature drift. As proposed, the temperature drift behavior m_{MP} of the measurement pixels can be determined using a closure mechanism.

In one embodiment of the method according to the invention, the temperature drift components T_{drift} are determined from the temperature drift behavior m_{MP} of the measurement pixels by virtue of the temperature drift components T_{drift} of the respective measurement pixels being calculated in the form of a function as a product of temperature drift behavior m_{MP} and initial measurement deviations T_{MP,offset} of the respective measurement pixels.

This embodiment of the method emerges analogously to the determination of the temperature drift behavior m_{MP} of the measurement pixels as a constant of proportionality between initial measurement deviations T_{MP,offset} of the measurement pixels and temperature measurement values T_{MP}^{blind}. For the purposes of determining the temperature drift components T_{drift}, the associated initial measurement deviations T_{MP,offset} are initially determined from the initial offset map for each measurement pixel to be evaluated. In principle, it should be noted that the measurement pixels to be evaluated for the purposes of determining the temperature drift component T_{drift} can be distinguished from the measurement pixels that are used to determine the temperature drift behavior m_{MP}.

Subsequently, a temperature drift component T_{drift} belonging to a measurement pixel can be calculated as a product of the temperature drift behavior m_{MP} and the initial measurement deviation T_{MP,offset} belonging to the corresponding measurement pixel:

T_{drift}−m_{MP}·(T_{MP,offset}⁰−T_{MP,offset}).

This equation likewise represents a linear equation with the constant parameter T_{MP,offset}⁰. Here, T_{MP,offset}⁰ also can be zero, in particular.

Advantageously, this can realize a determination of the temperature drift components T_{drift} of the measurement pixels that can be carried out in a particularly simple and fast manner. In particular, the temperature of the closure mechanism does not need to be known. Further, requirements on the evaluation apparatus in respect of its computational power can be kept as low as possible using this determination method, and consequently it is possible to save costs.

In one embodiment of the method according to the invention, the temperature drift components T_{drift} are determined from the temperature drift behavior m_{MP} of the measurement pixels by virtue of the temperature drift components T_{drift} of the respective measurement pixels being calculated in the form of a function as a product of the temperature drift behavior m_{MP} and the sensitivities of the initial measurement deviations ∂T_{MP,offset} in relation to the influences of aging of the respective measurement pixels.

This embodiment of the method emerges analogously to the determination of the temperature drift behavior m_{MP} of the measurement pixels as a constant of proportionality between sensitivities of the initial measurement deviations ∂T_{MP,offset} of the measurement pixels and temperature measurement values T_{MP}^{blind}.

For the purposes of determining the temperature drift components T_{drift}, the associated sensitivities of the initial measurement deviations ∂T_{MP,offset} are initially determined from the initial drift susceptibility map for each measurement pixel to be evaluated. Subsequently, a temperature drift component T_{drift} belonging to a measurement pixel can be calculated as a product of the temperature drift behavior m_{MP} and the sensitivities of the initial measurement deviations ∂T_{MP,offset} belonging to the corresponding measurement pixel:

T_{drift}−m_{MP}·(∂T_{MP,offset}⁰−∂T_{MP,offset})

This equation likewise represents a linear equation with the constant parameter ∂T_{MP,offset}⁰, Here, a T_{MP,offset}⁰ also can be zero, in particular.

Advantageously, this can realize a determination of the temperature drift components T_{drift} of the measurement pixels that can be carried out in a particularly simple and fast manner. In particular, the temperature of the closure mechanism does not need to be known. Further, requirements on the evaluation apparatus in respect of its computational power can be kept as low as possible using this determination method, and consequently it is possible to save costs.

In a further method step in one embodiment of the method according to the invention, an incidence of infrared radiation onto the infrared detector array is suppressed by means of the closure mechanism of the infrared measurement system and the temperature measurement values T_{MP} are each corrected by a pixel-dependent deviation ΔT_{MP}^{blind} from a mean value <T_{MP}^{blind}> of all temperature measurement values T_{MP}^{blind} measured in the case of a suppressed incidence of infrared radiation.

Since the temperature drift in the non-ideal application can be slightly different on an individual basis for each measurement pixel this can advantageously implement a further correction of the temperature measurement values T_{MP}, in particular a homogenization or a reduction of the variance. In particular, this correction can be implemented for the temperature measurement values T_{MP} that have already been corrected in terms of the temperature drift component T_{drift} according to the method according to the invention.

To this end, in a further method step, an incidence of infrared radiation on the infrared detector array is suppressed, at least intermittently, by means of the closure mechanism of the infrared measurement system, in particular by means of a shutter. The temperature measurement values T_{MP}^{blind} of the measurement pixels established thereupon will vary about a temperature value that corresponds to the temperature of the closure mechanism. A mean value <T_{MP}^{blind}> formed from all temperature measurement values that were measured when the incidence of infrared radiation was suppressed will come very close to this temperature of the closure mechanism. Therefore, calculating a pixel-dependent deviation ΔT_{MP}^{blind} from the mean value <T_{MP}^{blind}> for all measurement pixels allows temperature measurement values T_{MP} of each measurement pixel to be corrected by precisely this deviation ΔT_{MP}^{blind} and consequently allows homogenization of the temperature measurement values T_{MP} output by the totality of all measurement pixels.

This further method step of homogenization can be implemented following the correction of the temperature measurement values T_{MP} of the measurement pixels by the temperature drift component T_{drift}. As an alternative or in addition thereto, the homogenization can also take place at any other time, for example before the temperature drift component T_{drift} is calculated.

### DRAWINGS

The invention is explained in more detail in the subsequent description on the basis of exemplary embodiments that are illustrated in the drawings. The drawing, the description and the claims contain numerous features in combination. Expediently, a person skilled in the art will also consider the features individually and combine these to form meaningful further combinations. The same reference signs in the figures denote the same elements.

In the drawing:

FIG. 1 shows an embodiment of an infrared measurement system according to the invention in a perspective front view,

FIG. 2 shows an embodiment of an infrared measurement system according to the invention in a perspective rear view,

FIG. 3 shows a perspective, schematic rear view of the infrared measurement system according to the invention in front of an object to be measured,

FIG. 4 shows a schematic illustration of the components of the infrared measurement system according to the invention that are required to carry out the method according to the invention,

FIG. 5 shows a schematic top view of an embodiment of the infrared detector array according to the invention,

FIG. 6 shows an embodiment of the method according to the invention in a flowchart,

FIG. 7a shows an “initial offset map”, which assigns initial measurement deviations T_{MP,offset} to measurement pixels of the infrared detector array,

FIG. 7b shows an “initial drift susceptibility map”, which assigns sensitivities of the initial measurement deviations a T_{MP,offset} to the measurement pixels of the infrared detector array,

FIG. 8 shows a schematic illustration of the evaluation method steps according to the invention when using the initial measurement deviations T_{MP,offset} for determining the temperature drift components T_{drift},

FIG. 9 shows a schematic illustration of the evaluation method steps according to the invention when using the initial drift susceptibilities ∂T_{MP,offset} for determining the temperature drift components T_{drift}, and

FIGS. 10a,b show a schematic illustration of the evaluation method steps according to the invention for homogenizing the temperature measurement values T_{MP} (a) before homogenization and (b) after homogenization of the temperature measurement values T_{MP}.

### DESCRIPTION OF EXEMPLARY EMBODIMENTS

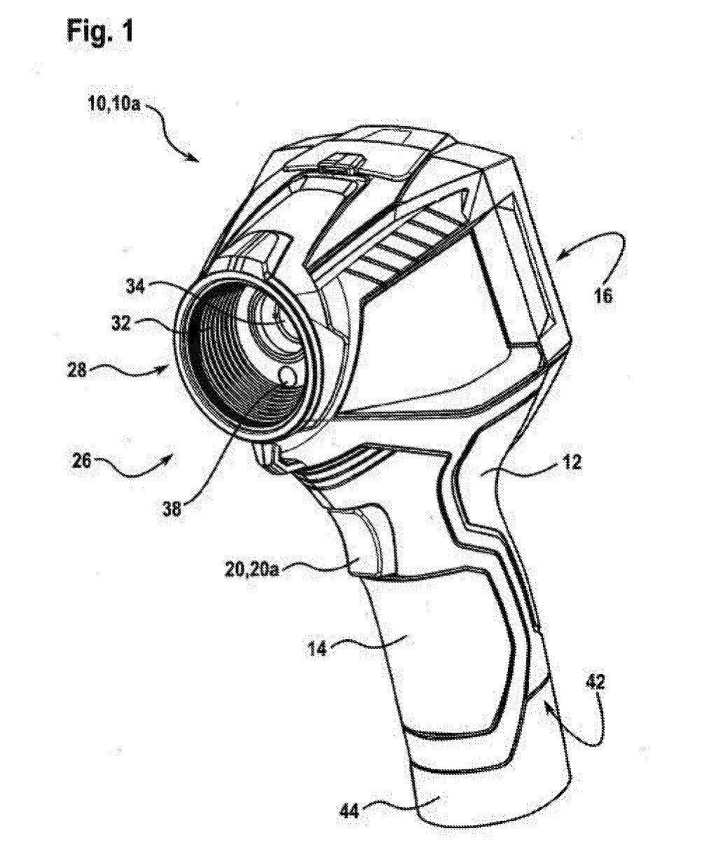

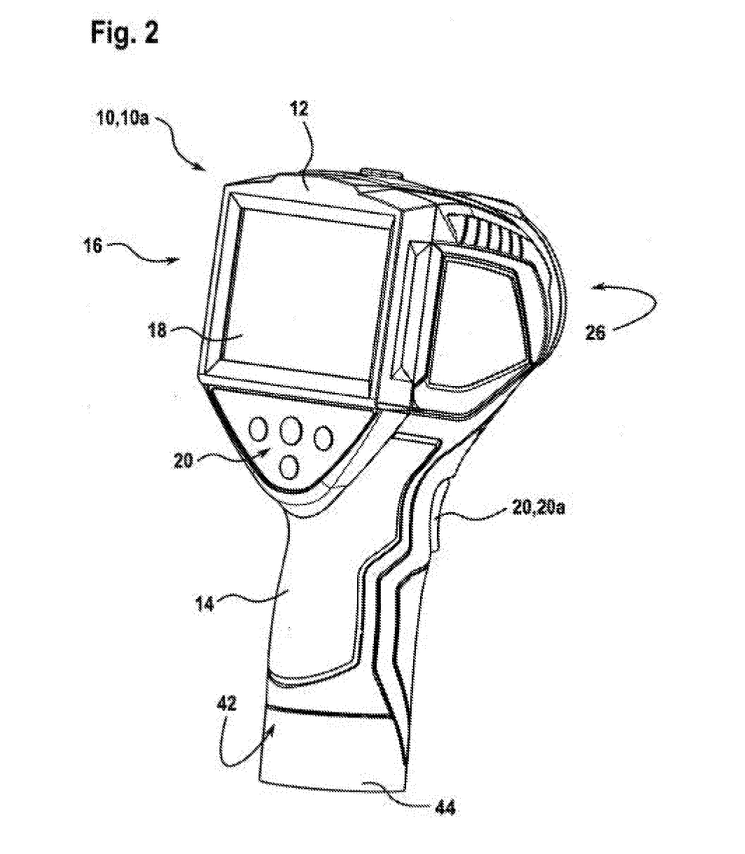

An infrared measurement system 10 according to the invention in the form of a handheld thermal imaging camera 10a is presented below. FIG. 1 and FIG. 2 show an exemplary embodiment of this thermal imaging camera 10a in a perspective front view and in a perspective rear view, respectively. The thermal imaging camera 10a comprises a housing 12 with a handle 14. The handle 14 allows the thermal imaging camera 10a to be held comfortably in one hand during its use. Furthermore, the housing 12 of the thermal imaging camera 10a has an output device in the form of a touch-sensitive display 18 and operating elements 20 for user input and control of the thermal imaging camera 10a on a side 16 facing a user during the use of the thermal imaging camera 10a. In particular, the thermal imaging camera 10a has a trigger 20a, by means of which a user can trigger a contactless establishment of a temperature of a surface 22 of an object 24 to be examined, in particular a temperature distribution on a surface 22 of an object 24.

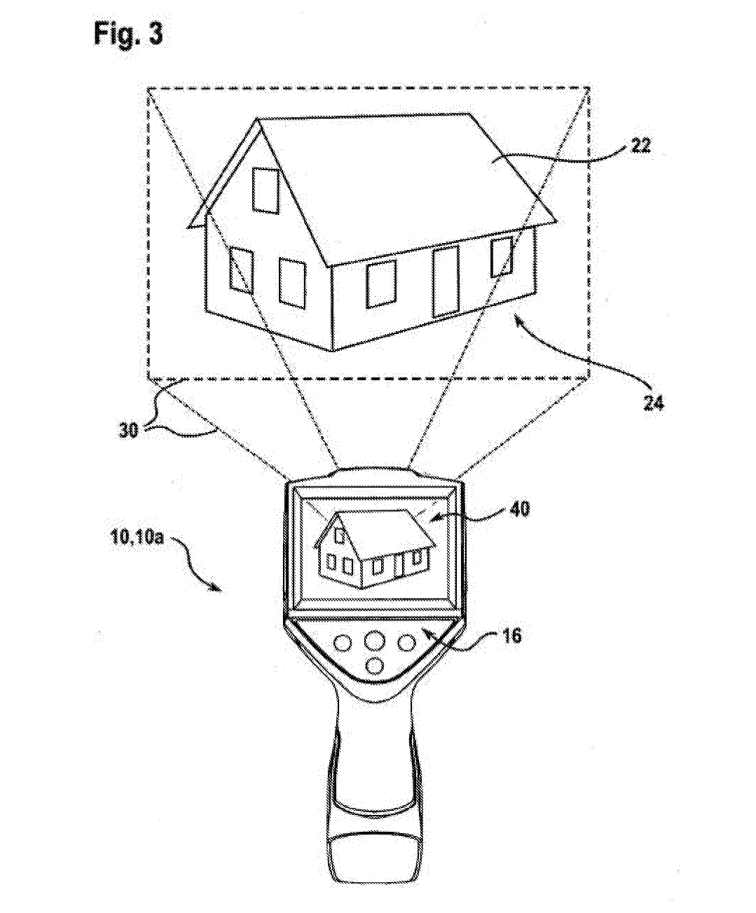

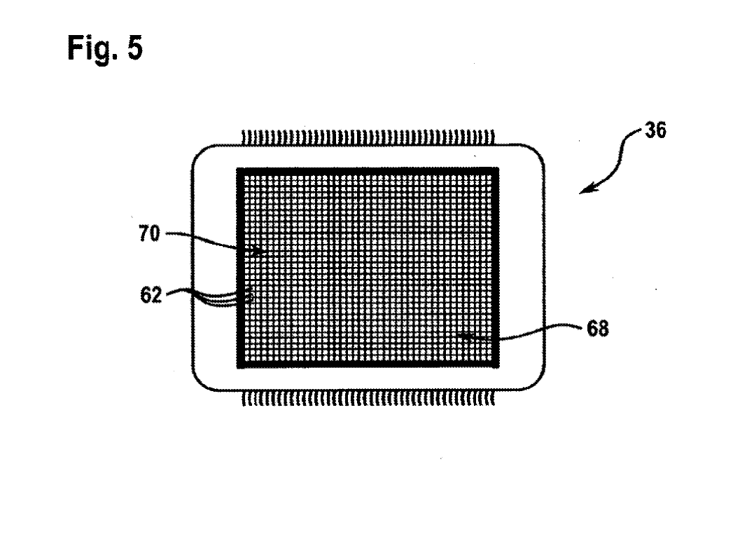

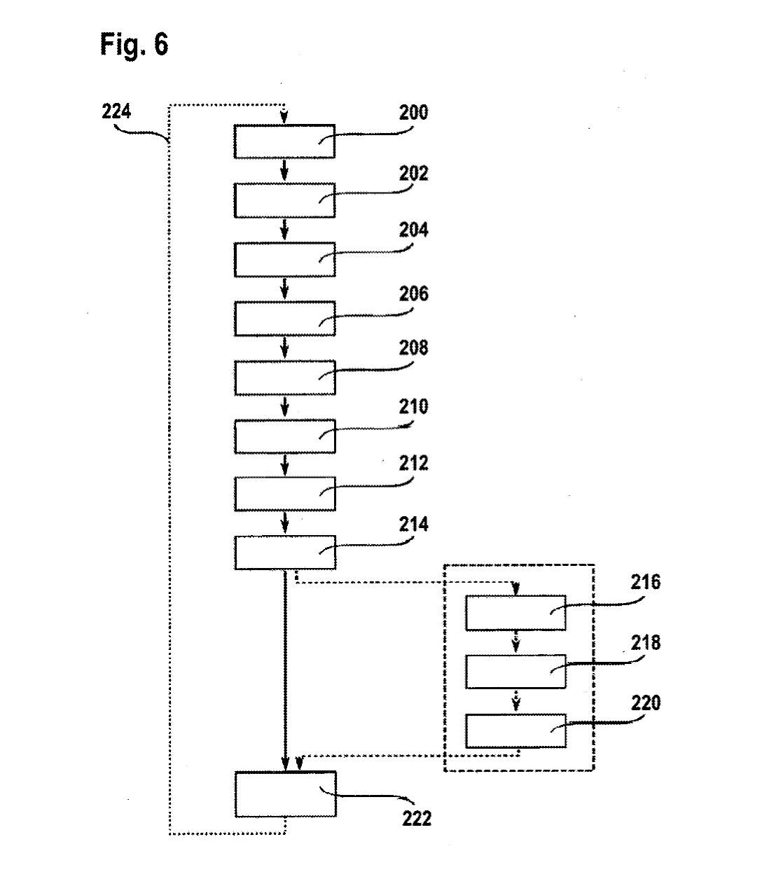

An entrance opening 28 in the housing 12 is provided on the side 26 of the housing 12 facing away from the user, thermal radiation emitted by the object 24, in particular emitted in a measurement region 30 (see the dashed solid angle in FIG. 3) of a surface 22 of the object 24, being able to enter into the thermal imaging camera 10a through said entrance opening. A lens system 34 as an optical unit is situated directly behind the entrance opening 28 in a light tube 36 that reduces stray light. The lens system 34 is transmissive for radiation in the mid-wavelength infrared range and it serves to focus thermal radiation on an infrared detector array 36 (see, in particular, the explanations in relation to FIG. 5 and FIG. 6) of the thermal imaging camera 10a.

Further, a camera 38 operating in the visual spectrum, by means of which a visual image of the measurement region 30 is recorded, is provided on the side 26 of the housing 12 facing away from a user during the use of the thermal imaging camera 10a in one exemplary embodiment of the thermal imaging camera 10a. This visual image can be output together with a thermal image 40 that was generated by a temperature measurement initiated by the user, in particular output in a manner at least partly superposed or overlaid on the thermal image 40. By way of example, the camera 38 can be realized as a CCD image sensor.

On the lower side of the thermal imaging camera 10a, the handle 14 has a receptacle 42 for receiving an energy store 44 which, for example, may be embodied in the form of a rechargeable accumulator or in the form of batteries.

The thermal imaging camera 10a serves to record a thermal image 40 of an object 24 to be examined, as illustrated schematically in FIG. 3. After activation of the thermal imaging camera 10a, the thermal imaging camera 10a contactlessly detects thermal radiation emitted from the surface 22 of the object 24 in the measurement region 30. The temperature established by the thermal imaging camera 10a characterizes the temperature of the surface 22 and should be understood to be a temperature distribution in this exemplary embodiment, said temperature distribution preferably being output in the form of a spatially resolved thermal image 40 to the user of the thermal imaging camera 10a. As a consequence of the trigger 20a being actuated by the user of the thermal imaging camera 10a, a thermal image 40 that is corrected by a temperature drift component T_{drift} 46 is produced, output on the display 18 and stored in this exemplary embodiment.

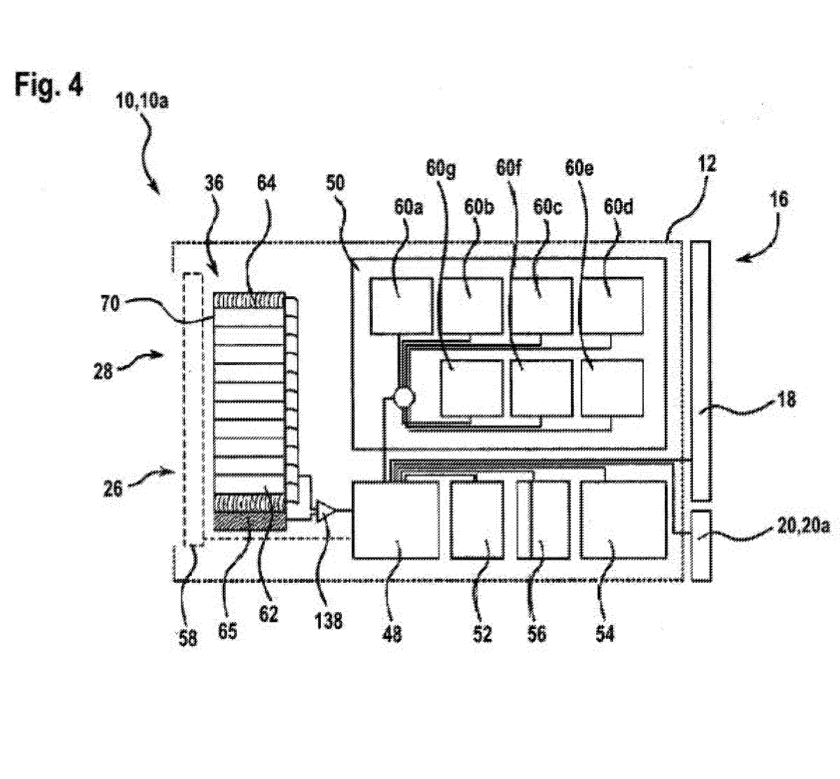

FIG. 4 schematically illustrates the components of the thermal imaging camera 10a according to the invention that are required to carry out the method according to the invention (see FIG. 6, in particular). These components are housed within the housing 12 of the thermal imaging camera 10a as electrical components and wired to one another. The components essentially comprise the infrared detector array 36, a control apparatus 48, an evaluation apparatus 50, a data communications interface 52, an energy supply apparatus 54, a data memory 56 and a closure mechanism 58.

The infrared detector array 36 of the thermal imaging camera 10a comprises at least a plurality of measurement pixels 62 which are provided to capture thermal radiation from the infrared radiation spectrum, which, emanating from the surface 22 of the object 24 to be examined in the measurement region 30, enters the entrance opening 28 of the thermal imaging camera 10a (see FIG. 3). The thermal radiation entering into the entrance opening 28 is focused onto the infrared detector array 36 by means of the lens system 34, with illumination of at least a plurality of measurement pixels 62 (not illustrated in any more detail here).

Each measurement pixel 62 is provided to provide an electrical measurement signal U_{MP}, for example a potential, at its output, said electrical measurement signal correlating with the radiated-in thermal output of the infrared radiation P_{MP} on the measurement pixel 62. These pixel-dependent measurement signals U_{MP} are initially output to the control apparatus 48 of the infrared measurement system, either individually or in combination with other measurement signals of other measurement pixels 62, and transmitted from said control apparatus to the evaluation apparatus 50 of the infrared measurement system 10.

In particular, the control apparatus 48 of the infrared measurement system 10 represents an apparatus which comprises at least one control electronics unit and means for communication with the other components of the thermal imaging camera 10a, in particular means for open-loop and closed-loop control of the thermal imaging camera 10a. The control apparatus 48 is provided to control the thermal imaging camera 10a and to facilitate the operation thereof. To this end, the control apparatus 48 is signal-connected to the other components of the measurement appliance, in particular the infrared detector array 36 (via a circuit), the evaluation apparatus 50, the data communications interface 52, the energy supply apparatus 54, the data memory 56, the closure mechanism 58, and also the operating elements 20, 20a and the touch-sensitive display 18.

In FIG. 4, the energy supply apparatus 54 is preferably realized by the energy store 44 illustrated in FIG. 1 and FIG. 2.

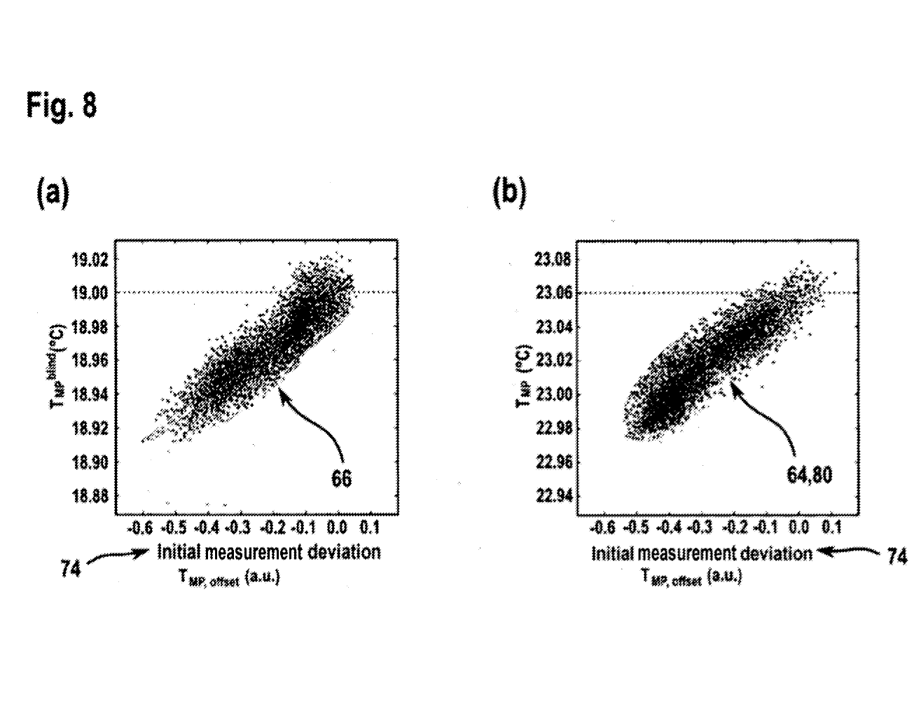

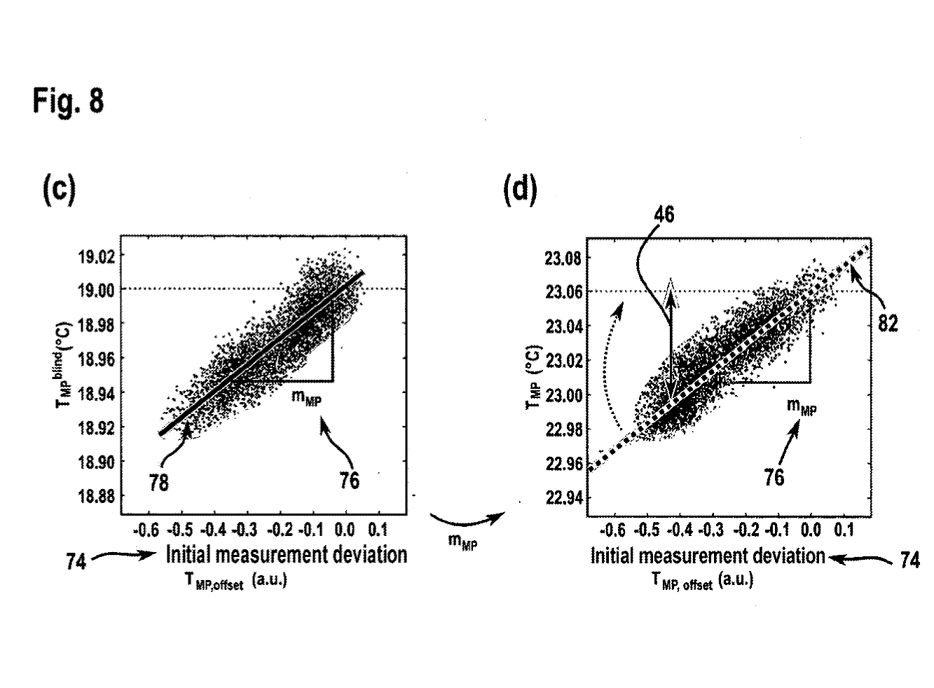

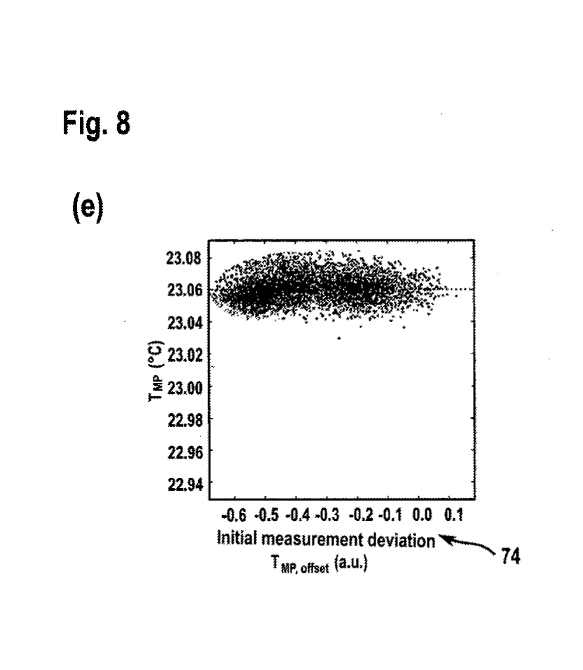

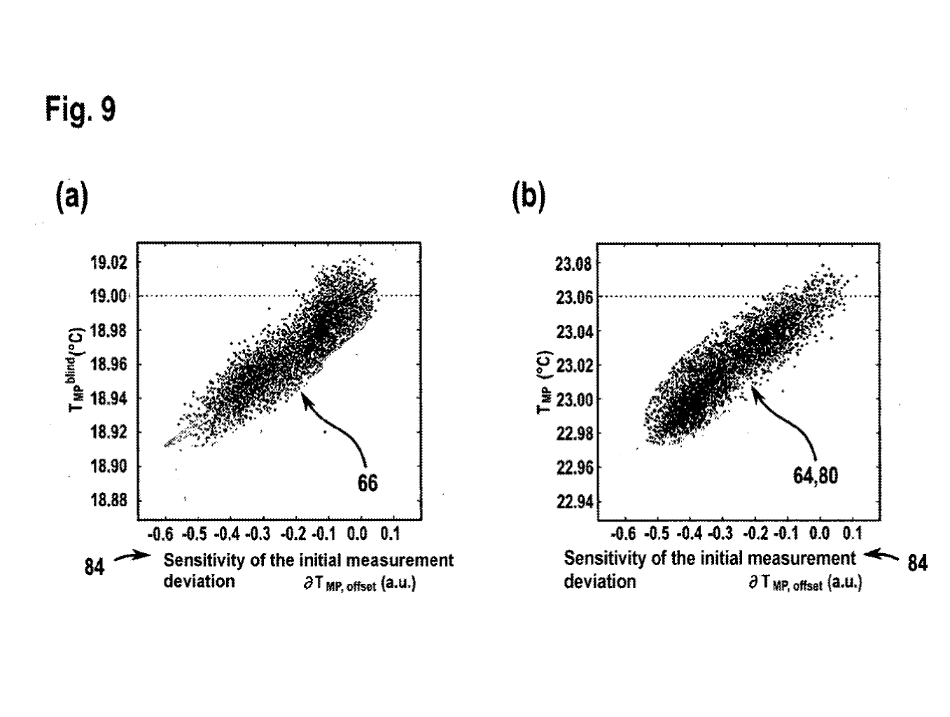

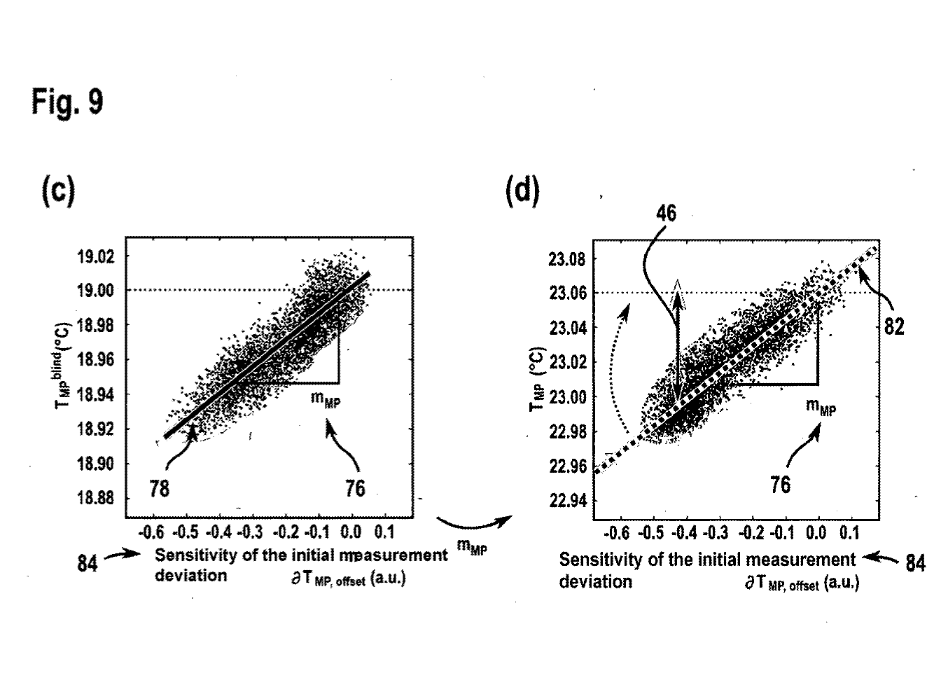

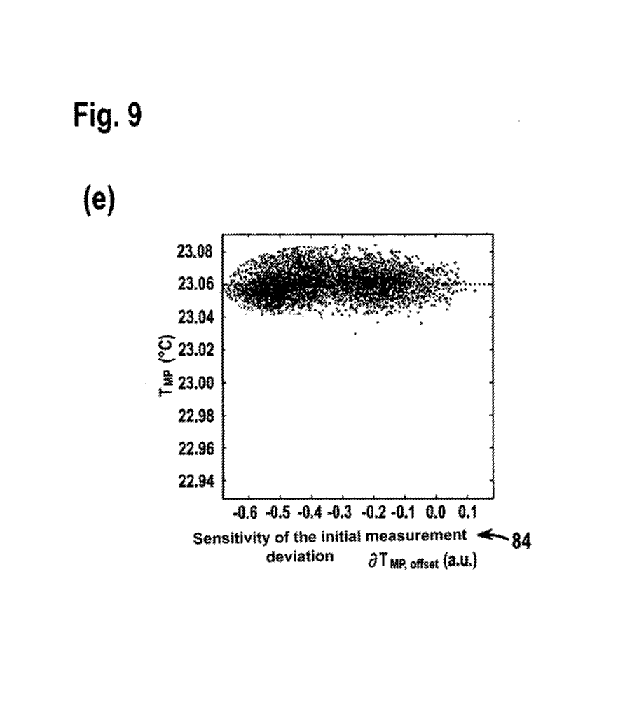

The evaluation apparatus 50 serves to receive and evaluate measurement signals of the infrared detector array 36, i.e., the measurement signal U_{MP} of the measurement pixels 62. The evaluation apparatus 50 has a plurality of functional blocks 60a-60f, which serve to process information, in particular to evaluate the received measurement signals. The evaluation apparatus further comprises a processor, a memory and an operating program with evaluation and calculation routines (each not illustrated in any more detail). The evaluation apparatus 50 is provided to receive and evaluate (functional block 60a) measurement signals provided by the infrared detector array 36, in particular measurement signals U_{MP} provided by measurement pixels 62. In this way, temperature measurement values T_{MP} (reference sign 64; see FIGS. 8 and 9, in particular) of a plurality of measurement pixels 62 are determined. Temperature measurement values established while the closure mechanism 58 suppresses an incidence of infrared radiation onto the infrared detector array are labeled by T_{MP}^{blind} (reference sign 66; see FIGS. 8 and 9) but should be treated analogously to temperature measurement values T_{MP} from an evaluation point of view.

The evaluated temperature measurement values, in particular T_{MP} 64 and/or T_{MP}^{blind} 66 can be provided for further processing to the control apparatus 48 by the evaluation apparatus 50.

Further, the evaluation apparatus 50 is provided to correct temperature measurement values T_{MP} 64 by a pixel-associated temperature drift component T_{drift} (reference sign 46; see FIGS. 8 and 9, in particular) in each case. This correction is carried out by functional block 60e. The pixel-associated temperature drift component T_{drift} 46 is evaluated by functional blocks 60b to 60d. The method steps that are satisfied or worked through by functional blocks 60a-60e are described in detail in conjunction with FIGS. 6, 8 and 9.

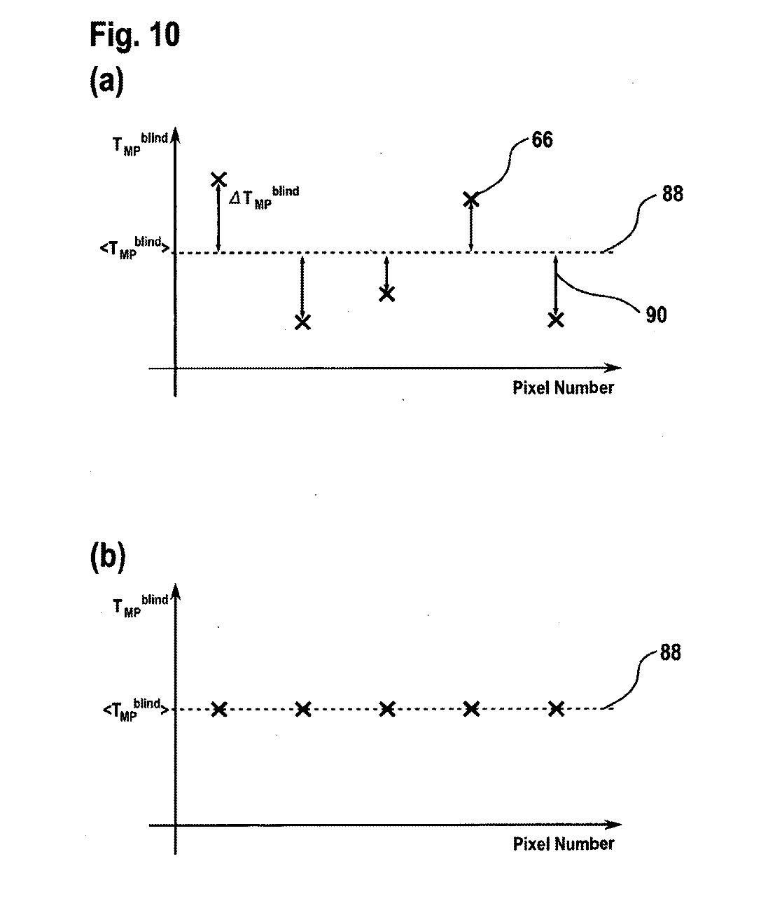

In an alternative or additional exemplary embodiment of the infrared measurement system 10, the evaluation apparatus 50 further has a functional block 60f (illustrated using dashed lines), which serves to homogenize or reduce the variance of the temperature measurement values T_{MP} 64, which have already been corrected by the temperature drift component T_{drift} 46 according to the method according to the invention. The functionality of this functional block 60f is described in detail in the explanation relating to FIG. 10.

Overall, the thermal imaging camera 10a, in particular the evaluation apparatus 50 thereof, is provided to carry out an evaluation of a thermal image 40 of the measurement region 30 on the basis of measurement signals from at least a plurality of measurement pixels 62, in particular on the basis of temperature measurement values T_{MP}^{blind}, with the thermal image 40 being corrected in respect of a pixel-associated temperature drift component T_{drift} 46.

The temperature measurement values T_{MP} 64 and temperature measurement values T_{MP}^{blind} 66 evaluated by the evaluation apparatus 50, the pixel-associated temperature drift components T_{drift} 46, the temperature measurement values T_{MP}^{corr} corrected by the pixel-associated temperature drift components T_{drift} 46 and thermal images composed from these data, in particular the thermal image 40 to be output, are provided to the control apparatus 48 by the evaluation apparatus 50 for further processing. In this way, there can be an output to a user of the thermal imaging camera 10a using the display 18 of the output apparatus. As an alternative or in addition thereto, the output can be implemented to an external data appliance (not illustrated in any more detail), such as, e.g., a smartphone, a computer or the like, using the data communications interface 52. Here, in the illustrated exemplary embodiment, the data communications interface 52 is embodied as a WLAN and/or Bluetooth interface. Moreover, an output to the data memory 56 for storing the established data and thermal images is conceivable.

FIG. 5 shows a schematic plan view of an embodiment of the infrared detector array 36 of the thermal imaging camera 10a according to the invention from the direction of view of the incident measurement radiation. In simplified fashion, each measurement pixel 62 is represented by a square. In an exemplary fashion, the plurality of measurement pixels 62 are arranged in a matrix-like fashion in the form of an array 88 on the surface 70 of the infrared detector array 36. In this exemplary embodiment, the number of measurement pixels 62 is 42×32 in an exemplary fashion. Any other values are conceivable. The method according to the invention is described below on the basis of FIGS. 6 to 9.

FIG. 6 illustrates a flowchart which reproduces an embodiment of the method according to the invention for contactlessly establishing the temperature of the surface 22, in particular for contactlessly establishing a thermal image 40 of the surface 22. The method is provided to be operated by a thermal imaging camera 10a, as was presented in conjunction with FIGS. 1 to 5.

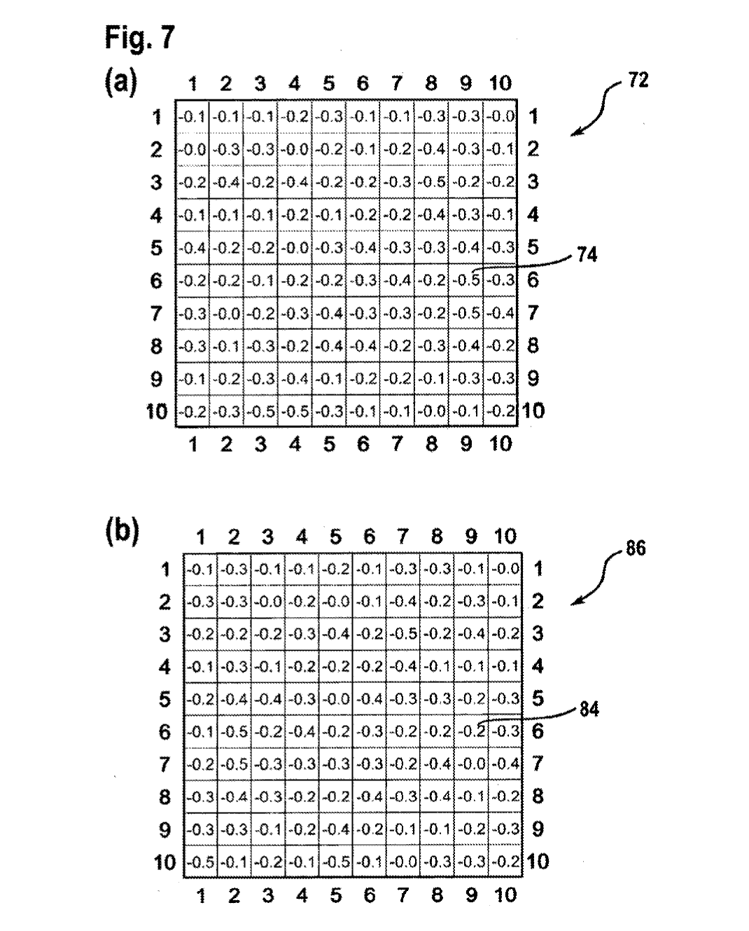

Proceeding from the measurement scenario illustrated in FIG. 3, a user of the thermal imaging camera 10a is interested in examining the temperature distribution on the surface 22 of an object 24. For the purposes of measuring the surface 22, the user directs the thermal imaging camera 10a onto the object 24 to be examined. In the meantime, the thermal imaging camera 10a continuously captures infrared radiation from the measurement region 30 by means of the infrared detector array 36 and, in the meantime, continuously displays a non-corrected thermal image on the display 18. In a first method step 200, the user actuates the trigger 20a of the thermal imaging camera 10a and thereby initiates the determination of the temperature drift components T_{drift} 46 and the correction of the established temperature measurement values T_{MP} 64 of the measurement pixels 62. In an alternative exemplary embodiment of the method, this initiation can be implemented in automated fashion, in particular repeated after a time interval or in virtually continuous fashion (see dashed arrow 228 in FIG. 7).

Subsequently, the control apparatus 48 transmits the measurement signals U_{MP}, provided by the infrared detector array 36 at the time of initiation, to the evaluation apparatus 50. In method step 202, the evaluation apparatus 50 determines the temperature measurement values T_{MP} 64 of a plurality of measurement pixels 62 from their measurement signals U_{MP}. In this exemplary embodiment, these temperature measurement values T_{MP} are temperature measurement values to be corrected according to the method according to the invention. The temperature measurement values T_{MP} are determined from the measurement signals in functional block 60a of the evaluation apparatus 50; see FIG. 4. Here, the functional block 60a converts the respective measurement signals U_{MP} into temperature measurement values T_{MP} 64. These temperature measurement values T_{MP} 64 serve to produce a thermal image 40 of the object 24 to be examined. The goal of the further method is to subject these temperature measurement values T_{MP} 64 to a correction in respect of the temperature drift component T_{drift} 46.

To this end, in method step 204, an incidence of infrared radiation onto the infrared detector array 36 is at least intermittently suppressed by means of the closure mechanism 58 of the infrared measurement system 10 while the temperature measurement values T_{MP}^{blind} 66 are determined in method step 206 in a manner analogous to method step 202. These temperature measurement values T_{MP}^{blind} 66 that are independent of the incident infrared radiation form the basis according to the invention of the correction by the temperature drift component T_{drift} 46.

Subsequently, the evaluation apparatus 50 loads the “initial offset map” 72, as illustrated in FIG. 7a, from the data memory 56. By means of the initial offset map 72, the evaluation apparatus 50 assigns unique initial measurement deviations T_{MP,offset} 74 to the temperature measurement values T_{MP}^{blind} 66 of a plurality of measurement pixels 62 (in principle any plurality of measurement pixels) in method step 208. In FIG. 7a (and also 7b), the unique identification of the pixels is ensured in each case, for example, by way of the line and column number thereof. Here, the evaluation apparatus 50 forms value pairs (T_{MP}^{blind}, T_{MP,offset}) for each measurement pixel 62 to be evaluated by reading initial measurement deviations T_{MP,offset} 74, assigned to the respective measurement pixels 62, from the initial offset map 72. Method step 208 is carried out in functional block 60b of the evaluation apparatus 50; see FIG. 4.

The value pairs (T_{MP}^{blind}, T_{MP,offset}) can be presented by plotting the established temperature measurement values T_{MP}^{blind} 66 on the ordinate axis against the initial measurement deviations T_{MP,offset} 74 on the abscissa axis. Subsequently, the evaluation apparatus 50 calculates the temperature drift behavior m_{MP} 76 of the measurement pixels 62 in method step 210 from the temperature measurement values T_{MP}^{blind} 66 of the measurement pixels 62 as a gradient (constant of proportionality) of a straight line 78, which models the plotted value pairs particularly well; see FIG. 8c. In particular, the following general equation applies to this straight line 78:

T_{MP}^{blind}=m_{MP}·(T_{MP,offset}⁰−T_{MP,offset}),

where T_{MP,offset}⁰ is the abscissa intercept and m_{MP} 76 is the temperature drift behavior of the measurement pixels 62 as a constant of proportionality. The temperature drift behavior m_{MP} 76 of the measurement pixels 62 is determined in functional block 60c of the evaluation apparatus 50; see FIG. 4.

In method step 212, the evaluation apparatus 50 determines the pixel-dependent temperature drift components T_{drift} 46 for the already established temperature measurement values T_{MP} 64 (not T_{MP}^{blind} 66), which should be corrected by the temperature drift components T_{drift} 46—i.e., for which the temperature measurement values T_{MP} were determined in method step 202. For the purposes of determining the temperature drift components T_{drift} 46, the method according to the invention uses the temperature drift behavior m_{MP} 76 of the measurement pixels 62 determined from the temperature measurement values T_{MP}^{blind} 66.

The evaluation apparatus 50 now initially determines the associated initial measurement deviations T_{MP,offset} 74 for each measurement pixel 62 to be evaluated, for which there is present a temperature measurement value T_{MP} 64 to be corrected, from the initial offset map 72 loaded in conjunction with method step 208 (see FIG. 7a). The temperature measurement values T_{MP} 66 (ordinate) of a plurality of measurement pixels 62, which are plotted against the initial measurement deviations T_{MP,offset} 74 (abscissa), are illustrated as a point cloud 80 in FIG. 8b. Thereupon, it is possible to calculate a temperature drift component T_{drift} 46 belonging to a measurement pixel 62 as a product of the temperature drift behavior m_{MP} 76 and the initial measurement deviation T_{MP,offset} 74 belonging to the corresponding measurement pixel 62 according to the formula

T_{drift}=m_{MP}·(T_{MP,offset}⁰−T_{MP,offset})

This is illustrated in FIG. 8d as the dashed, calculated straight line 82, along which the values for the temperature drift component T_{drift} 46, which are dependent on the initial measurement deviation T_{MP,offset} (abscissa axis), lie. The pixel-dependent temperature drift behavior T_{drift} 46 according to method step 212 is determined in functional block 60d of the evaluation apparatus 50; see FIG. 4.

Consequently, the evaluation apparatus 50 determines the temperature drift components T_{drift} 46 from the temperature measurement values T_{MP}^{blind} 66 of the measurement pixels 64 in method steps 206 to 212, using the functional blocks 60a to 60d of the evaluation apparatus 50.

In method step 214, there is the final actual correction of the temperature measurement values T_{MP} 66 of the measurement pixels 62 by the temperature drift component T_{drift} 46 determined for the respective measurement pixel 62 by subtracting the two values. According to the illustration in FIGS. 8d and 8e, the straight line 82 is subtracted from the values of the point cloud 80, and so this correction can be elucidated by rotating the point cloud 80 representing the temperature measurement values T_{MP} 64 of the measurement pixels 62 (left-hand arrow in FIG. 8d). Method step 214 is carried out in functional block 60e of the evaluation apparatus 50; see FIG. 4.

In an alternative or additional embodiment of the method, the “sensitivity of the initial measurement deviations ∂T_{MP,offset} in relation to the influences of aging” 84 of the measurement pixels 62 also can be used in place of the initial measurement deviations T_{MP,offset} 74. In a manner equivalent to the representations in FIG. 8 and in FIG. 6, the evaluation is then carried out in such a way that, for the purposes of determining the temperature drift components T_{drift} 46, the temperature drift behavior m_{MP}^{blind} 76 of the measurement pixels 62 is determined as a constant of proportionality (gradient) between sensitivities of the initial measurement deviations ∂T_{MP,offset} 84 of the measurement pixels 62 and temperature measurement values T_{MP}^{blind} 66 (see the equivalence of FIG. 8 and FIG. 9 apart from the abscissa axis label). Further, in a manner equivalent to FIG. 8d, the temperature drift components T_{drift} 46 are determined from the temperature drift behavior m_{MP} 76 by virtue of the temperature drift components T_{drift} 46 of the respective measurement pixels 62 being calculated in the form of a function as a product of temperature drift behavior m_{MP} and sensitivities of the initial measurement deviations ∂T_{MP,offset} 110 of the respective measurement pixels 62 (see the equivalence of FIG. 8 and FIG. 9 apart from the abscissa axis label). In particular, this exemplary embodiment of the method according to the invention resorts to an “initial drift susceptibility map” 86 that is kept available in the data memory 56 (see FIG. 7b). In the manner equivalent to the method already described above, the evaluation apparatus 50 then assigns unique sensitivities of the initial measurement deviations ∂T_{MP,offset} 84 to the temperature measurement values 66 of a plurality of measurement pixels 62 using the initial drift susceptibility map 86 (FIG. 7b) in a method step that is equivalent to method step 208.

In an alternative or additional exemplary embodiment, the temperature measurement values T_{MP} 64 can be homogenized. In the exemplary embodiment of the method according to the invention, shown in FIG. 6, this homogenization can be carried out following the correction of the temperature measurement values T_{MP} 64 of the measurement pixels 62 by the temperature drift component T_{drift} 46, i.e., after method step 214. As an alternative or in addition thereto, the homogenization can also be implemented at any other time, for example prior to calculating the temperature drift component T_{drift} 46, i.e., before method step 204.

Now, in method step 216, the incidence of infrared radiation on the infrared detector array 36 is initially suppressed by means of the closure mechanism 58 and the temperature measurement values T_{MP}^{blind} 66 are read. In FIG. 10a, five temperature measurement values T_{MP}^{blind} 66 are plotted in a diagram in exemplary fashion. Subsequently, a mean value <T_{MP}^{blind}> 88 is calculated in method step 218 from these temperature measurement values T_{MP}^{blind} 66, said mean value coming very close to the temperature of the closure mechanism 58. Here, the actual temperature of the closure mechanism 58 is irrelevant. In FIG. 10a, the mean value <T_{MP}^{blind}> 88 is illustrated as a dashed line. Now, calculating a pixel-dependent deviation ΔT_{MP}^{blind} 90 from the mean value <T_{MP}^{blind}> 88 (small arrows in FIG. 10a) for the read measurement pixels 62 renders it possible to correct each measurement pixel 62 by precisely this deviation ΔT_{MP}^{blind} 90 in method step 2220 and thus to homogenize the temperature measurement values T_{MP}^{blind} 66 or to adjust the mean value <T_{MP}^{blind}> 88. The latter is illustrated in FIG. 10b, in which the temperature measurement values T_{MP}^{blind} 66 lie on the dashed line illustrating the mean value <T_{MP}^{blind}> 88 after the homogenization was carried out. The deviation ΔT_{MP}^{blind} 90 determined using the temperature measurement values T_{MP}^{blind} 66 is transferable to the yet to be determined, or already determined, temperature measurement values T_{MP} 64, and so, according to the invention, there can likewise be homogenization of the temperature measurement values T_{MP} 64 established in the case of an open closure mechanism 58.

Method steps 216 to 220 are carried out in functional block 60f of the evaluation apparatus 50; see FIG. 4.

Subsequently, in method step 222, the corrected and possibly homogenized thermal image 40 is output to the user of the thermal imaging camera 10a using the display 18.

1. A method for contactlessly establishing a temperature of a surface using an infrared measurement system, the infrared measurement system including (i) an infrared detector array with a plurality of measurement pixels, each of the plurality of measurement pixels providing a measurement signal for establishing a temperature measurement value dependent on an intensity of the incident infrared radiation and (ii) a closure mechanism for suppressing an incidence of infrared radiation onto the infrared detector array, the method comprising:
determining the temperature measurement values of the plurality of measurement pixels;
correcting the temperature measurement values by using in each case a pixel-associated temperature drift component;
at least temporarily suppressing an incidence of infrared radiation onto the infrared detector array using the closure mechanism of the infrared measurement system while temperature measurement values are being determined; and
determining the temperature drift components using the temperature measurement values.

2. The method as claimed in claim 1, further comprising:
determining a temperature drift behavior of the plurality of measurement pixels from the temperature measurement values in order to determine the temperature drift components.

3. The method as claimed in claim 2, further comprising:
determining the temperature drift behavior of the plurality of measurement pixels as a constant of proportionality between initial measurement deviations of the plurality of measurement pixels and the temperature measurement values in order to determine the temperature drift components.

4. The method as claimed in claim 3, further comprising:
determining the temperature drift behavior of the plurality of measurement pixels as a constant of proportionality between sensitivities of the initial measurement deviations in relation to the influences of aging of the plurality of measurement pixels and the temperature measurement values in order to determine the temperature drift components.

5. The method as claimed in claim 2, further comprising:
determining the temperature drift components from the temperature drift behavior of plurality of measurement pixels.

6. The method as claimed in claim 5, further comprising:
determining the temperature drift components from the temperature drift behavior of the plurality of measurement pixels using the temperature drift components of respective measurement pixels being calculated in form of a first function as a first product of temperature drift behavior and initial measurement deviations of the respective measurement pixels.

7. The method as claimed in claim 6, further comprising:
determining the temperature drift components from the temperature drift behavior of the plurality of measurement pixels by using the temperature drift components of the respective plurality of measurement pixels being calculated in the form of a second function as a second product of the temperature drift behavior and the sensitivities of the initial measurement deviations in relation to influences of aging of the respective measurement pixels.

8. The method as claimed in claim 1, further comprising:
determining the temperature drift components repeatedly at time intervals, in particular regularly, preferably continuously or virtually continuously.

9. The method as claimed in claim 1, further comprising:
suppressing an incidence of infrared radiation onto the infrared detector array using the closure mechanism of the infrared measurement system and the temperature measurement values are each corrected by a pixel-dependent deviation from a mean value of all temperature measurement values measured in case of a suppressed incidence of infrared radiation.

10. An infrared measurement system for contactlessly establishing a temperature distribution on a surface, comprising:
an infrared detector array with a plurality of measurement pixels, each of the plurality of measurement pixels configured to provide a measurement signal for establishing a temperature measurement value dependent on an intensity of the incident infrared radiation;
a closure mechanism configured to suppress an incidence of infrared radiation onto the infrared detection array; and
an evaluation apparatus configured to:
determine the temperature measurement values of the plurality of measurement pixels;
correct the temperature measurement values by using in each case a pixel-associated temperature drift component;
at least temporarily suppress an incidence of infrared radiation onto the infrared detector array using the closure mechanism of the infrared measurement system while temperature measurement values are being determined; and
determine the temperature drift components using the temperature measurement values.

11. The method as claimed in claim 1, wherein the method is configured for contactlessly establishing a temperature distribution on a surface.

12. The infrared measurement system as claimed in claim 10, wherein the infrared measurement system is a handheld thermal imaging camera.
